(19) United States
(12) Patent Application Publication
(10) Pub. No.: US 2023/0390863 A1
(43) Pub. Date: Dec. 7, 2023

(54) LASER MACHINING CONDITION DETERMINATION METHOD AND DETERMINATION DEVICE

(71) Applicant: Panasonic Intellectual Property Management Co., Ltd., Osaka (JP)

(72) Inventors: Kazuki FUJIWARA, Osaka (JP); Koji FUNAMI, Kyoto (JP); Izuru NAKAI, Osaka (JP)

(21) Appl. No.: 18/234,575

(22) Filed: Aug. 16, 2023

Related U.S. Application Data
(63) Continuation of application No. PCT/JP2022/005378, filed on Feb. 10, 2022.

(30) Foreign Application Priority Data
Feb. 26, 2021 (JP) 2021-029933

(51) Int. Cl. B23K 26/03; B23K 26/244; G06N 20/00

(52) U.S. Cl. CPC B23K 26/032; B23K 26/244; G06N 20/00

(57) ABSTRACT

A determination method for determining a processing state includes detecting, using an optical sensor, at least one of heat radiation light, visible light, and reflected light generated at a welded portion formed at a surface of a workpiece by emission of a laser beam on the workpiece, obtaining a signal indicating a change in at least one of heat radiation light, visible light, and reflected light in a time section corresponding to a welding time of each workpiece, calculating a feature quantity including a gradient of a straight line approximating a signal waveform of the signal in a predetermined section in the time section, determining, as the processing state, a shift including farness and closeness of a focal position of the laser beam in an emission direction of the laser beam by inputting the calculated feature quantity to a determination model that determines the processing state.

### TECHNICAL FIELD

The present disclosure relates to a determination method and a determination device for determining a processing state in laser processing for lap welding.

### BACKGROUND ART

PTL 1 discloses a determination method for determining a welding state in laser welding, the method being applied to a laser welding method of welding by emitting a pulsed laser beam on a workpiece and used for determining whether a welding state of the workpiece is good or poor, for example. In the method in PTL 1, the intensity of plasma light and reflected light emitted from the workpiece during laser welding is detected as detection light intensity, and a feature value of each pulse is extracted for each pulse of the laser beam based on the detection light intensity in an extraction section preset in a single cycle of the detection light intensity corresponding to a single pulse of the laser beam. As the feature value of each pulse, an average of the detection light intensity, a change amount resulting from difference processing, and an amplitude resulting from difference processing are calculated, for example. In the method in PTL 1, the lowest value or the highest value of the feature value of each pulse is obtained as an extreme value, the extreme value is compared with a predetermined threshold value, and whether a welding defect has occurred is determined as a welding state of each workpiece.

### CITATION LIST

### Patent Literature

PTL 1: Unexamined Japanese Patent Publication No. 2000-153379

### SUMMARY OF THE INVENTION

According to one aspect of the present disclosure, a determination method for determining a processing state in laser processing for lap welding is provided. The present method includes detecting, using an optical sensor, at least one of heat radiation light, visible light, and reflected light generated at a welded portion formed at a surface of a workpiece by emission of a laser beam on a workpiece, obtaining a signal indicating a change in at least one of heat radiation light, visible light, and reflected light in a time section corresponding to a welding time of each workpiece, calculating a feature quantity including a gradient of a straight line approximating a signal waveform of the signal in a predetermined section in the time section, determining, as the processing state, a shift including farness and closeness of a focal position of the laser beam in an emission direction of the laser beam by inputting the calculated feature quantity to a determination model that determines the processing state, and outputting the determined shift of the focal position as a determination result. The determination model is constructed based on training data including the feature quantity calculated under a condition in which the shift of the focal position is present and the shift of the focal position, the feature quantity and the shift of the focal position being associated with each other.

According to one aspect of the present disclosure, a determination device for determining a processing state in laser processing for lap welding is provided. The determination device includes an arithmetic circuit and a communication circuit. The communication circuit receives a signal generated by detecting, by an optical sensor, at least one of heat radiation light, visible light, and reflected light generated at a welded portion formed at a surface of a workpiece by emission of a laser beam on the workpiece. The signal indicates a change in at least one of heat radiation light, visible light, and reflected light in a time section corresponding to a welding time of each workpiece. The arithmetic circuit obtains a signal by the communication circuit, calculates a feature quantity including an inclination of a straight line that approximates a signal waveform of the signal in a predetermined section in a time section, determines, as the processing state, a shift including farness and closeness of a focal position in an emission direction of the laser beam by inputting the calculated feature quantity to a determination model that determines a processing state, and outputs the determined shift of the focal position as a determination result by the communication circuit. The determination model is constructed based on training data including the feature quantity calculated under a condition in which the shift of the focal position is present and the shift of the focal position, the feature quantity and the shift of the focal position being associated with each other.

### BRIEF DESCRIPTION OF THE DRAWINGS

FIG. 1 is a diagram illustrating an overview of a determination system according to a first exemplary embodiment of the present disclosure.

FIG. 2 is a diagram illustrating a configuration of a laser processing device of the determination system.

FIG. 3 is a diagram illustrating a configuration of a spectral device of the determination system.

FIG. 4 is a block diagram illustrating a configuration of the determination device of the determination system.

FIG. 5 is a flowchart illustrating a determination process of the determination device.

FIG. 6 is a diagram for explaining a signal obtained by the determination device.

FIG. 7 is a diagram for explaining a process of calculating a feature quantity in the determination device.

FIG. 8 is a diagram for explaining a determination model process in the determination device.

FIG. 9 is a flowchart illustrating a training process for the determination model.

FIG. 10 is a diagram for explaining training data for the determination model.

### DESCRIPTION OF EMBODIMENT

In laser welding, when a processing state changes during emission of a laser beam, such as when the position of a focal point in an emission direction of the laser beam is shifted from a surface of a workpiece (workpiece), a joint area decreases, and this decrease may cause a joint defect. To investigate a cause of such a joint defect, a detailed analysis of the processing state is necessary. In the method of determining whether a welding defect has occurred, it is difficult to determine in detail why the shift of the focal position has occurred.

The present disclosure provides a determination method and a determination device capable of determining in detail a processing state in laser processing for lap welding.

Exemplary embodiments will be described below in detail with reference to the drawings as appropriate. However, unnecessarily detailed description may be omitted. For example, detailed description of already well-known matters and repeated description of substantially the same configurations may be omitted. These are to avoid an unnecessarily redundant description and to facilitate understanding of a person skilled in the art. Note that, the attached drawings and the following description are presented by the inventor so that those skilled in the art can fully understand the present disclosure, and are not intended to limit the subject matter as described in the claims.

### First Exemplary Embodiment

In a first exemplary embodiment, as an example of using a determination method and a determination device according to the present disclosure, a determination system will be described that detects a component of light generated in laser processing for lap welding, obtains a signal based on the detected component, and determines a processing state.

1. Configuration

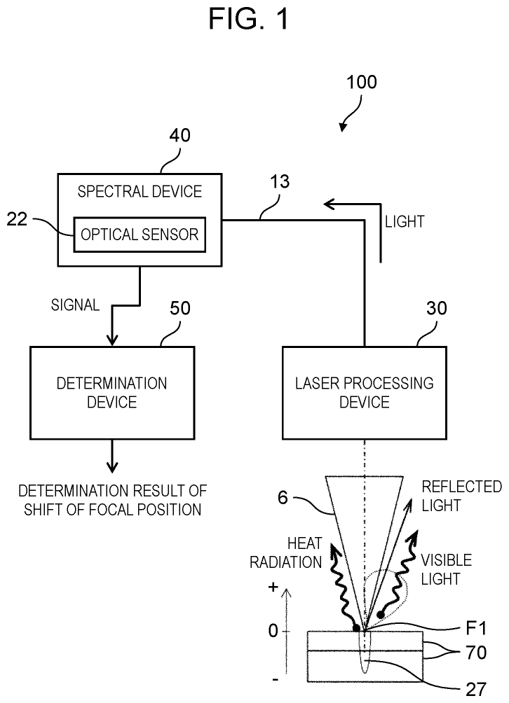

The determination system according to the first embodiment will be described with reference to FIG. 1. FIG. 1 is a diagram illustrating an overview of determination system 100 according to the exemplary embodiment.

1-1. System Overview

Determination system 100 includes laser processing device 30 that performs laser processing for lap welding, spectral device 40 for detecting a component of light, and determination device 50. Determination device 50 is an example of the determination device according to the present disclosure. Workpiece 70 subjected to lap welding is made of, for example, a metal. Emission of laser beam 6 on workpiece 70 generates heat radiation light (also referred to as “heat radiation”) in a near-infrared light region due to a temperature rise and causes a light emission specific to a metal or plasma light emission that mainly contain components of visible light. A portion of laser beam 6 that does not contribute to the processing is reflected to be a return light. As described above, emission of laser beam 6 by laser processing device 30 on workpiece 70 generates heat radiation, visible light, and reflected light at molten portion 27, which is an example of a welded portion formed in workpieces 70.

The generated light is condensed in laser processing device 30 and transmitted to spectral device 40 through optical fiber 13 connecting laser processing device 30 to spectral device 40. The light transmitted to spectral device 40 is dispersed into heat radiation, visible light, and reflected light that are then detected by optical sensor 22 of spectral device 40 and converted into signals. On receiving the signals from spectral device 40, determination device 50 determines a shift of focal position F1 of laser beam 6 and outputs the determination result.

The shift of focal position F1 is determined by a numerical value indicating farness and closeness (“−” or “+”) in an emission direction with respect to a reference value of “0”, where the reference value represents a position where laser beam 6 emitted on workpiece 70 takes the minimum spot diameter near a surface of workpiece 70. The reference position may be any position on an optical path of laser beam 6. For example, the reference position may be near a surface of workpiece 70. When laser processing is to be performed on a plurality of workpieces 70, the reference position may be a focal position for laser processing performed on a certain workpiece 70. For example, laser processing device 30 may store the focal position for the initial laser processing and use this focal position as the reference for a shift of a focal position in the second and the subsequent ones of laser processing.

1-2. Configuration of Laser Processing Device

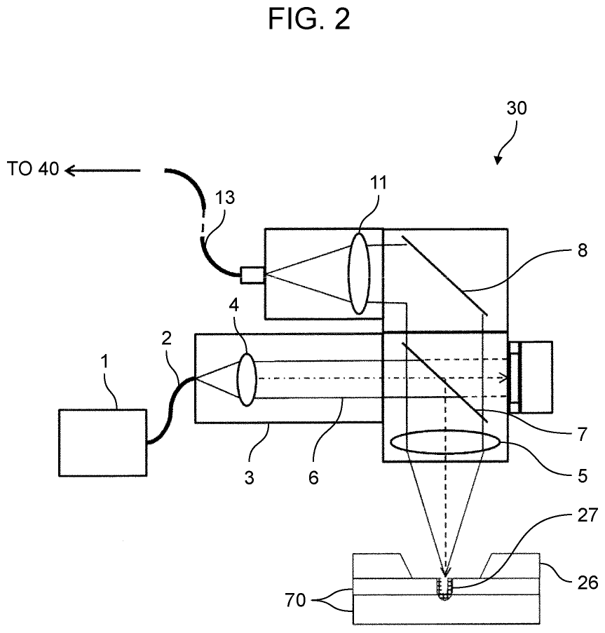

FIG. 2 is a diagram illustrating a configuration of laser processing device 30 of the present exemplary embodiment. Laser processing device 30 includes laser oscillator 1, laser transmission fiber 2, lens barrel 3, collimating lens 4, condenser lenses 5 and 11, first mirror 7, and second mirror 8.

Laser oscillator 1 supplies light for generating pulsed laser beam 6 having a wavelength of, for example, about 1070 nanometers (nm). The light supplied from laser oscillator 1 is amplified while being transmitted through laser transmission fiber 2, passes through collimating lens 4 for obtaining a parallel beam, forms into laser beam 6, and travels straight in lens barrel 3. Lens barrel 3 constitutes a processing head of laser processing device 30.

Laser beam 6 is reflected by first mirror 7 except for a portion passing through first mirror 7, and reflected laser beam 6 is condensed by condenser lens 5 and emitted on workpiece 70 fixed on a scanning table (not illustrated) by hold jig 26, for example. Laser processing for lap welding of workpieces 70 is thereby performed. The wavelength of laser beam 6 is not particularly limited to 1070 nm. A wavelength having a high absorption rate in a material is preferably used.

By emission of laser beam 6, heat radiation from workpiece 70, visible light of plasma emission, and reflected light of laser beam 6 are generated at molten portion 27. These lights pass through first mirror 7, are reflected by second mirror 8, condensed by condenser lens 11, and then transmitted to spectral device 40 through optical fiber 13. A portion of light that passes through second mirror 8 may be detected by a camera or a sensor.

1-3. Configuration of Spectral Device

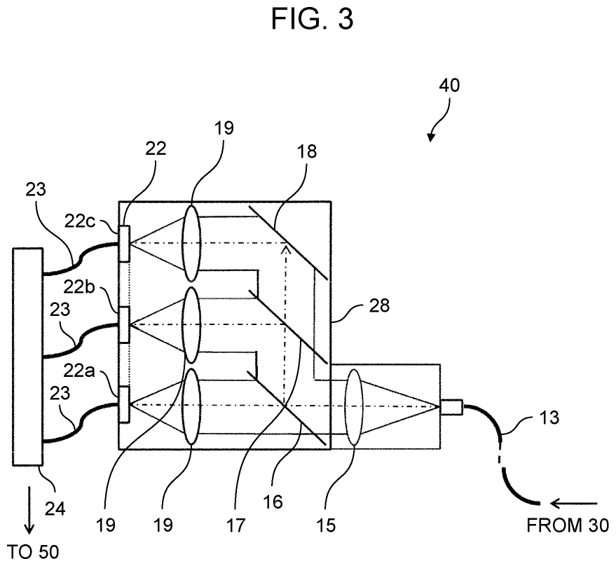

FIG. 3 is a diagram illustrating a configuration of spectral device 40 of the present exemplary embodiment. Spectral device 40 includes, in housing 28, collimating lens 15, third mirror 16, fourth mirror 17, fifth mirror 18, condenser lenses 19, 20, 21, optical sensor 22, transmission cables 23, and controller 24. Housing 28 prevents other lights from entering from outside spectral device 40 and leakage of light from inside spectral device 40.

Collimating lens 15 changes the light transmitted from laser processing device 30 through optical fiber 13 into a parallel light again. Third mirror 16 lets visible light having a wavelength of 400 nm to 700 nm, for example, pass therethrough and reflects the rest of the light components. Fourth mirror 17 reflects the reflected light of laser beam 6 having a wavelength of about 1070 nm, for example, and transmits the rest of the light components. Fifth mirror 18 reflects heat radiation having a wavelength of 1300 nm to 1550 nm, for example.

The light that has passed through collimating lens 15 is dispersed by third mirror 16, fourth mirror 17, and fifth mirror 18 into visible light, reflected light, and heat radiation, and the dispersed lights are each condensed by condenser lenses 19 to 21. Any selected bandpass filter may be disposed in each of the optical paths respectively coming from third mirror 16, fourth mirror 17, and fifth mirror 18 to select a certain wavelength of the light that passes through the bandpass filter.

Optical sensor 22 includes, for example, optical sensors 22a, 22b, 22c each having high sensitivity for a wavelength that differs among optical sensors 22a, 22b, 22c. Optical sensors 22a, 22b, 22c detect visible light, reflected light, and heat radiation condensed by condenser lenses 19 to 21, respectively, and each generate an electric signal corresponding to the intensity of the detected light. Note that, optical sensor 22 may be a single optical sensor capable of detecting the intensity of each wavelength.

The electrical signal generated by optical sensor 22 is transmitted to controller 24 via transmission cables 23. Controller 24 is a hardware controller, and integrally controls all the operations of spectral device 40. Controller 24 includes a CPU and a communication circuit, and transmits the electric signal received from optical sensor 22 to determination device 50. Controller 24 includes, for example, an A/D converter, and converts an analog electric signal into a digital signal (also simply referred to as “signal”). Note that, the sampling period of conversion into a digital signal is preferably, for example, 1/100 or less of a time for performing output control of laser beam 6 from the viewpoint of securing a sufficient number of samples to capture a feature of processing and local behavior of a physical quantity for determining the processing state.

1-4. Configuration of Determination Device

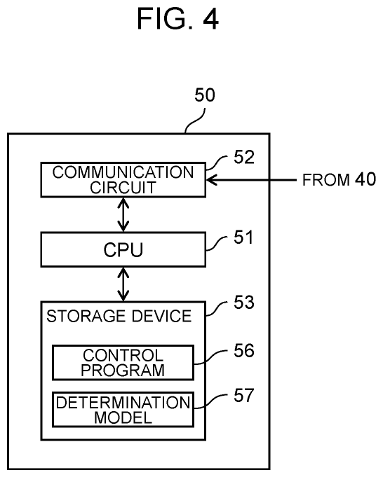

FIG. 4 is a block diagram illustrating a configuration of determination device 50 of the present exemplary embodiment. Determination device 50 is, for example, an information processing device such as a computer. Determination device 50 includes CPU 51 that performs arithmetic processing, communication circuit 52 for communication with other devices, and storage device 53 that stores data and a computer program.

CPU 51 is an example of an arithmetic circuit of the determination device of the present exemplary embodiment. CPU 51 implements predetermined functions including training and execution of determination model 57 by executing control program 56 stored in storage device 53. Determination device 50 implements a function as the determination device of the present exemplary embodiment by CPU 51 executing control program 56. Note that, the arithmetic circuit configured as CPU 51 in the present exemplary embodiment may be implemented by a processor of various kinds such as an MPU and a GPU, or may be configured by one or a plurality of processors.

Communication circuit 52 is a communication circuit that performs communication in accordance with a standard such as IEEE 802.11, 4G, and 5G. Communication circuit 52 may perform wired communication in accordance with a standard such as Ethernet (registered trademark). Communication circuit 52 is connectable to a communication network such as the Internet. Determination device 50 may directly communicate with another device via communication circuit 52, or may communicate via an access point. Note that, communication circuit 52 may be configured to be able to communicate with other devices without a communication network. For example, communication circuit 52 may include a connection terminal such as a USB (registered trademark) terminal and an HDMI (registered trademark) terminal.

Storage device 53 is a storage medium that stores a computer program and data necessary for implementing a function of determination system 100, and stores control program 56 executed by CPU 51 and data of various kinds. After construction of determination model 57, storage device 53 stores determination model 57. Determination model 57 is constructed based on training data including a feature quantity calculated under a condition in which a shift of focal position F1 of laser beam 6 is present and the shift of focal position F1. Details of determination model 57 will be described later.

Storage device 53 is configured as, for example, a magnetic storage device such as a hard disk drive (HDD), an optical storage device such as an optical disk drive, or a semiconductor storage device such as an SSD. Storage device 53 may include a temporary storage element configured by a RAM such as a DRAM and an SRAM, or may function as an internal memory of CPU 51.

2. Operation

In determination system 100 configured as described above, for example, as illustrated in FIG. 1, spectral device 40 detects by optical sensor 22 heat radiation, visible light, and reflected light generated at molten portion 27 by emission of laser beam 6. Spectral device 40 transmits a signal corresponding to the intensity of the detected heat radiation, visible light, and reflected light to determination device 50. The operation of determination device 50 of the present system 100 will be described below.

2-1. Determination Process

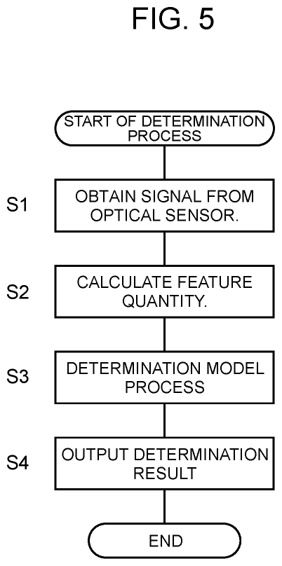

Hereinafter, a determination process of determining a shift of focal position F1 as a processing state performed by determination device 50 will be described with reference to FIGS. 5 to 8.

FIG. 5 is a flowchart illustrating a determination process performed by determination device 50 of the present exemplary embodiment. Each process in the flowchart is executed by, for example, CPU 51 of determination device 50. The flowchart starts by, for example, a user of determination system 100 giving a predetermined manipulation input for starting the determination process to an input device connected via communication circuit 52.

First, CPU 51 obtains, by communication circuit 52, signals corresponding to heat radiation, visible light, and reflected light detected by optical sensor 22 of spectral device 40 (S1).

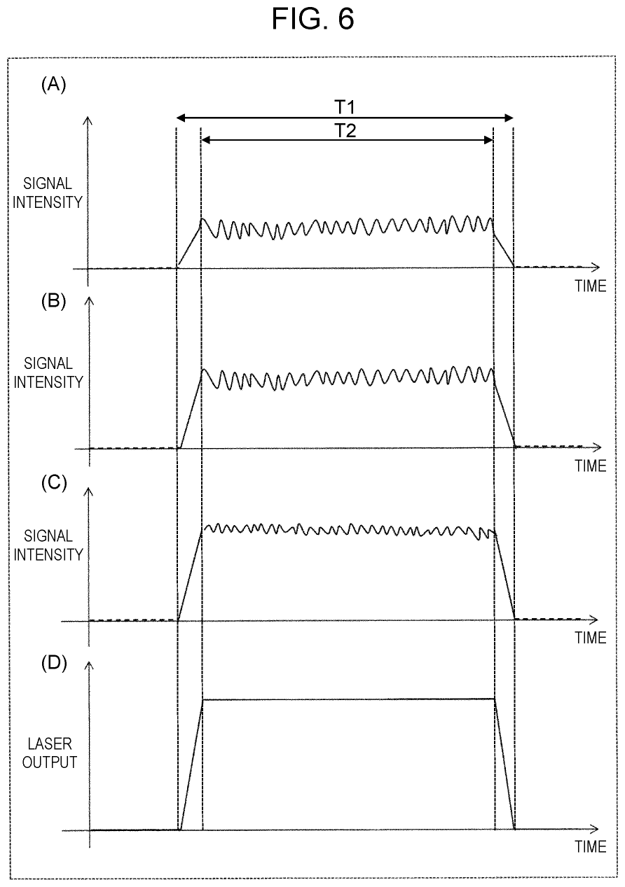

FIG. 6 is a diagram for explaining a signal obtained by determination device 50. Parts (A), (B), and (C) of FIG. 6 illustrate signal waveforms respectively corresponding to intensities of heat radiation, visible light, and reflected light. Part (D) of FIG. 6 illustrates an output of laser beam 6 emitted to workpiece 70. Signals in parts (A) to (C) of FIG. 6 respectively correspond to heat radiation, visible light, and reflected light generated by a laser output. In each of parts (A) to (D) of FIG. 6, the horizontal axis represents time, and the vertical axis represents signal intensity (in parts (A) to (C) of FIG. 6) or laser output (in part (D) of FIG. 6). Time T1 indicates a time section corresponding to a single pulse of laser beam 6, and time T2 indicates a time section of a peak output not including the rising section and the falling section of the laser output.

In laser processing device 30 of the present exemplary embodiment, welding is performed for each workpiece 70 in time T1 corresponding to a single pulse of laser beam 6. In step S1 in FIG. 5, as illustrated in parts (A) to (C) of FIG. 6, CPU 51 obtains signals indicating changes in heat radiation, visible light, and reflected light in time T1 corresponding to the welding time of each workpiece 70. Intensities of heat radiation, visible light, and reflected light are affected by residual heat of processing, and thus the end of a signal waveform may come later than the end of the laser output. Also in this case, the shift of the focal position can be determined without being affected by residual heat by extracting predetermined section T3 described later.

Next, CPU 51 calculates from the obtained signal a feature quantity to be input to determination model 57 (S2).

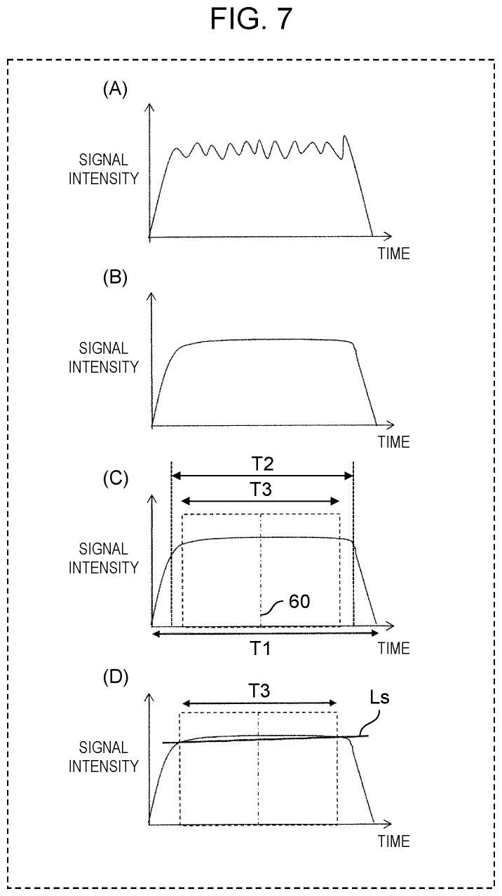

FIG. 7 is a diagram for explaining the process (S2) of calculating a feature quantity performed by determination device 50. Part (A) of FIG. 7 illustrates a temporal change in signal intensity of a signal corresponding to heat radiation, visible light, or reflected light where the vertical axis and the horizontal axis are the same as in parts (A) to (C) of FIG. 6. Part (B) of FIG. 7 illustrates a signal waveform obtained by applying a smoothing process to the signal in part (A) of FIG. 7. In step S2 in FIG. 5, CPU 51 performs, using a smoothing filter, a smoothing process on the signal of each component as in part (A) of FIG. 7 obtained in step S1, thereby generating a signal waveform as in part (B) of FIG. 7.

Part (C) of FIG. 7 illustrates times T1, T2, and predetermined section T3 in time T1 of the signal waveform in part (B) of FIG. 7. In step S2, CPU 51 draws straight line Ls that approximates the signal waveform in predetermined section T3 as illustrated in part (D) of FIG. 7, and calculates the gradient of straight line Ls as a feature quantity. Section T3 is previously set as, for example, a section of 1 to 3 milliseconds centered on center 60 of time T2 corresponding to the peak output of laser beam 6 in time T1 of a single pulse of laser beam 6. In the example in part (D) of FIG. 7, the gradient of straight line Ls defined by two points at two ends of section T3 and on the smoothed signal waveform is calculated as a feature quantity of gradient.

In the present exemplary embodiment, in step S2 in FIG. 5, CPU 51 calculates gradients of signal waveforms respectively corresponding to heat radiation, visible light, and reflected light as feature quantities. For heat radiation and visible light, in particular, that easily reflect a change in the molten state of the material of workpiece 70, use of the gradients of their signal waveforms enables accurately determining the shift of focal position F1.

Furthermore, in the present exemplary embodiment, in step S2 in FIG. 5, CPU 51 then calculates signal intensities as feature quantities by performing preprocessing such as normalization on the signals of heat radiation, visible light, and reflected light. The feature quantity of signal intensity is input to determination model 57 as, for example, the amplitude of the signal waveform for each sampling period for A/D conversion.

In step S2 of the present exemplary embodiment, CPU 51 then calculates as a feature quantity an integrated value of the signal intensity of the signal corresponding to reflected light. CPU 51 calculates, for example, an integrated value of the signal intensity in time T1. According to a signal waveform, the integrated value of signal intensity may be calculated by integrating the signal intensity only for time T2, section T3, or another time section which is shorter than time T1. Reflected light has a smaller variation in signal intensity than other components as in the example in part (C) in FIG. 6, and is considered to most reflect an output waveform of laser beam 6. Thus, use of the integrated value of signal intensity of reflected light enables determination accurately reflecting the change in light emission energy caused by the shift of focal position F1.

After the feature quantity is calculated (S2), CPU 51 performs a process (S3) of determining the shift of focal position F1 by inputting the feature quantity to determination model 57. In the present exemplary embodiment, in a determination model process (S3), CPU 51 determines a numerical value indicating the relative position of focal position F1 with respect to the reference position as the shift of focal position F1.

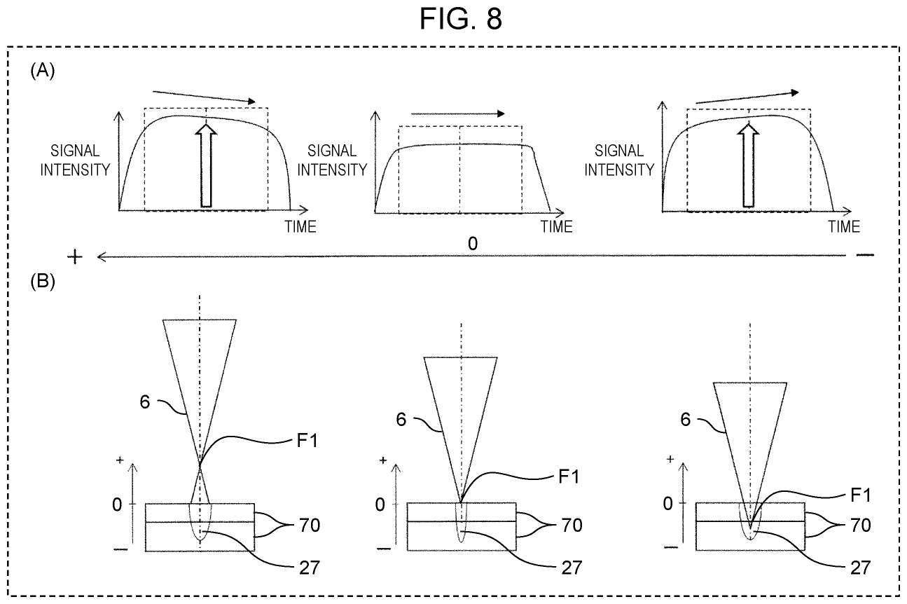

FIG. 8 is a diagram for explaining the determination model process (S3). FIG. 8 illustrates smoothed signal waveforms (part (A) of FIG. 8) respectively for cases when focal position F1 of laser beam 6 is on the plus (+) side, near “0” which is the reference position, and on the minus (−) side, and positional relationships (part (B) of FIG. 8) between focal position F1 of laser beam 6 and workpieces 70. In FIG. 8, the shift of focal position F1 is represented by coordinate axes as those in FIG. 1.

The determination model process (S3) is performed by determination model 57 learned on the basis of a correspondence relationship between a signal waveform and focal position F1 as illustrated in FIG. 8. The knowledge obtained by the inventor of the art in the present disclosure regarding the correspondence relationship between the signal waveform and focal position F1 will be described below with reference to FIG. 8.

When focal position F1 is near the reference “0”, that is, in a full focus state in which the spot diameter of laser beam 6 is minimum near a surface of workpiece 70, the gradient of a signal waveform is about “0”. When focal position F1 is shifted in the positive direction, the signal intensity is larger than in the full focus state and the gradient is small. When focal position F1 is shifted in the negative direction, the signal intensity is larger than in the full focus state and the gradient is also large. A small gradient means a negative gradient (the signal intensity decreases with time). A large gradient means a positive gradient (the signal intensity increases with time).

Why the signal intensity increases by the shift of focal position F1 is considered that the area on the surface of workpiece 70 on which laser beam 6 is emitted increases and thereby the area in molten portion 27 that emits light increases. With regard to the gradient of the signal waveform, at the start of welding processing, the surface of workpiece 70 melts and evaporates by emission of laser beam 6 and a cavity (keyhole) is formed in the surface. Formation of a keyhole requires heat input by laser beam 6. When there is a shift of focal position F1, the amount of heat input rises at a timing different from the timing in the state of full focus. This difference in timing is assumed to facilitate generation of heat radiation and visible light, in particular, at molten portion 27, and thereby changes the gradient of the signal waveform. When focal position F1 is shifted in the positive direction, the total amount of heat applied to the surface and the inside of workpiece 70 is small, and heat easily escapes because focal position F1 is outside workpiece 70. In contrast, when focal position F1 is shifted in the negative direction, the total amount of heat applied to the surface and the inside of workpiece 70 increases, and heat cannot easily escape because focal position F1 is inside workpiece 70. Accordingly, it may be understood that the shift of focal position F1 in the positive direction causes the gradient to be small, and the shift of focal position F1 in the negative direction causes the gradient to be large.

Based on the above knowledge, the present inventor has estimated that the shift of focal position F1 can be predicted from a signal corresponding to at least one of heat radiation, visible light, and reflected light using a feature quantity of gradient of signal waveform, signal intensity, or the like. As will be described later, the present inventor has constructed determination model 57 using the feature quantity and the shift of focal position F1 as training data to perform a determination process by determination model 57. According to determination model 57 constructed in this manner, when a feature quantity based on a signal is input, a shift including farness and closeness of focal position F1 is output (S3).

Referring back to FIG. 5, CPU 51 outputs, by communication circuit 52 (S4), the determination result of the shift of focal position F1 determined by the determination model process (S3). The determination result can be received and displayed by, for example, an external information processing device or a display device. Determination device 50 may include a display device (for example, a display) capable of communicating with CPU 51 and display the determination result on the display device.

Then, CPU 51 ends the flowchart in FIG. 5. The flowchart in FIG. 5 is repetitively executed, for example, when welding processing is performed for each workpiece 70.

According to the above determination process, determination device 50 of the present exemplary embodiment obtains the signal generated by optical sensor 22 of spectral device 40 (S1), calculates the feature quantity from the signal (S2), and determines the shift of focal position F1 by determination model 57 based on the feature quantity (S3). Accordingly, determination device 50 can determine in detail the shift of focal position F1 of laser beam 6 as the processing state in laser processing for lap welding.

Note that, in step S2 in FIG. 5, a gradient of a signal waveform and/or an integrated value of signal intensity may be calculated as a feature quantity for all or only one of heat radiation, visible light, and reflected light.

2-2. Training Process

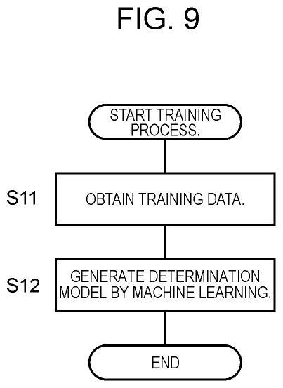

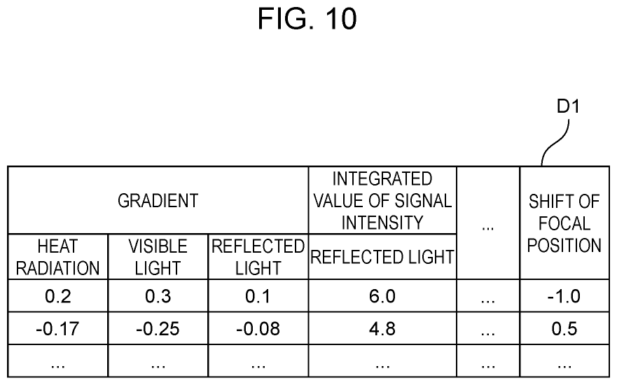

A training process for constructing determination model 57 will be described below with reference to FIGS. 9 and 10.

FIG. 9 is a flowchart illustrating a training process for determination model 57. Each process in the flowchart is executed by, for example, CPU 51 of determination device 50.

First, CPU 51 obtains, for example, training data previously stored in storage device 53 (S11).

FIG. 10 is a figure for explaining training data D1 for determination model 57. In training data D1, for example, feature quantities such as gradients of signal waveforms of heat radiation, visible light, and reflected light, an integrated value of signal intensity of reflected light, and signal intensities (not illustrated) of heat radiation, visible light, and reflected light are associated with a shift of focal position F1. Training data D1 is constructed by calculating feature quantities from signals based on heat radiation, visible light, and reflected light detected during actual laser processing under a plurality of conditions where the shift of focal position F1 changes, and recording the feature quantities in association with the corresponding shift of focal position F1.

Referring back to FIG. 9, on obtaining training data D1 (S1), CPU 51 performs machine learning using training data D1 and generates determination model 57 (S2). Determination model 57 is generated as a regression model based on, for example, linear regression, Lasso regression, ridge regression, decision tree, random forest, gradient boosting, support vector regression, Gaussian process regression, neural network, or k-nearest neighbor algorithm.

According to the above training process, determination model 57 can be generated as a learned model for determining the shift of focal position F1 from the feature quantities based on signals corresponding to heat radiation, visible light, and reflected light detected during laser processing.

Note that, the training process for determination model 57 may be performed in an information processing device other than determination device 50. Determination device 50 may obtain an already constructed determination model by communication circuit 52 via, for example, a communication network.

3. Effects

As described above, in the present exemplary embodiment, the determination process (S1 to S4) provides a determination method for determining the processing state in laser processing for lap welding. The present method includes detecting, using optical sensor 22, at least one of heat radiation (heat radiation light), visible light, and reflected light generated at molten portion 27 (an example of a welded portion) formed at a surface of workpiece 70 by emission of laser beam 6 on workpiece 70, obtaining a signal indicating a change in one of heat radiation, visible light, and reflected light in time T1 (time section) corresponding to a welding time of each workpiece 70 (S1), calculating a feature quantity including a gradient of straight line Ls approximating a signal waveform of the signal in predetermined section T3 in time T1 (S2), determining, as the processing state, a shift including farness and closeness of focal position F1 in an emission direction of laser beam 6 by inputting the calculated feature quantity to determination model 57 that determines the processing state (S3), and outputting the determined shift of focal position F1 as a determination result (S4). Determination model 57 is constructed based on training data D1 including the feature quantity calculated under a condition in which the shift of focal position F1 is present and the shift of focal position F1, the feature quantity and the shift of focal position F1 being associated with each other.

According to the above method, a signal based on at least one of detected heat radiation, visible light, and reflected light generated by emission of laser beam 6 is obtained (S1), a feature quantity such as the gradient of straight line Ls approximating a signal waveform is calculated (S2), and determination is performed by determination model 57 (S3). Accordingly, the processing state can be determined in detail by determination model 57 constructed using training data D1 in which the feature quantity of gradient of signal waveform or the like and the shift including farness and closeness of focal position F1 of laser beam 6 as the processing state are associated with each other.

In the present exemplary embodiment, determination model 57 includes a learned model generated (S11 to S12) by machine learning using training data D1 in which a feature quantity calculated from a signal based on at least one of heat radiation, visible light, and reflected light detected during laser processing under each condition of a plurality of conditions in which the processing state changes is associated with the shift of focal position F1 of each condition. Accordingly, determination model 57 for determining the shift of focal position F1 as the processing state is obtained from the feature quantity based on at least one of the detected heat radiation, visible light, and reflected light.

In the present exemplary embodiment, the shift of focal position F1 is determined with reference to a preset position on the lapping direction of lap welding. The shift of focal position F1 includes a numerical value indicating the relative position of focal position with respect to the reference position. Accordingly, the processing state in laser processing can be determined in detail including how far or close focal position F1 has shifted in the emission direction of laser beam 6.

In the present exemplary embodiment, the step (S2) of calculating a feature quantity includes smoothing the signal waveform of a signal before calculating the feature quantity. This makes it easy to calculate a feature quantity of gradient for a signal waveform in which the signal intensity finely fluctuates (see FIG. 6).

In the present exemplary embodiment, the feature quantity includes signal intensity of a signal. Thus, for example, the processing state can be determined by determination model 57 simply using information on a signal waveform corresponding to a temporal change of signal intensity.

In the present exemplary embodiment, the feature quantity includes an integrated value of signal intensity of a signal. This enables reflecting the tendency of signal intensity to increase with a shift of focal position F1 over a time during which a laser output continues, and makes it easy to determine the shift of focal position F1.

In determination system 100 of the present exemplary embodiment, determination device 50 is an example of a determination device for determining the processing state in laser processing for lap welding. Determination device 50 includes CPU 51 as an example of an arithmetic circuit, and communication circuit 52. Communication circuit 52 receives a signal generated by optical sensor 22 detecting at least one of heat radiation (heat radiation light), visible light, and reflected light generated at molten portion 27 (an example of a welded portion) formed at a surface of workpiece 70 by emission of laser beam 6 on workpiece 70. The signal indicates a change in at least one of heat radiation, visible light, and reflected light in time T1 as an example of a time section corresponding to the welding time of each workpiece 70. CPU 51 obtains the signal by communication circuit 52 (S1), calculates a feature quantity including the gradient of straight line Ls approximating the signal waveform of the signal in predetermined section T3 in time T1 (S2), determines, as the processing state, the shift including farness and closeness of focal position F1 in the emission direction of laser beam 6 by inputting the calculated feature quantity to determination model 57 that determines the processing state (S3), and outputs the determined shift of focal position F1 as a determination result by communication circuit 52 (S4). Determination model 57 is constructed based on training data D1 including the feature quantity calculated under a condition in which the shift of focal position F1 is present and the shift of focal position F1, the feature quantity and the shift of focal position F1 being associated with each other.

According to determination device 50 described above, the processing state in laser processing for lap welding can be determined in detail by performing the determination method described above.

### Other Exemplary Embodiments

As described above, the exemplary embodiment has been described as an example of the art disclosed in the present application. The art according to the present disclosure is, however, not limited to the above exemplary embodiment, and is applicable to other exemplary embodiments suitably made by modification, replacement, addition, or omission, for example. Furthermore, a different exemplary embodiment can also be made by a combination of the components of the exemplary embodiments described above.

In the first exemplary embodiment, determination device 50 calculates, as feature quantities, signal intensities of heat radiation, visible light, and reflected light and an integrated value of the signal intensity of reflected light in addition to gradients of signal waveforms of signals corresponding to heat radiation and visible light (S2). In the present exemplary embodiment, the feature quantity is not particularly limited to the above feature quantities. For example, only the gradient of a signal waveform may be used, or either a signal intensity or an integrated value may not be included. Only the signal intensity of at least one of heat radiation, visible light, and reflected light may be used as a feature quantity.

In the first exemplary embodiment, when calculating a feature quantity (S2), determination device 50 calculates a feature quantity of gradient after smoothing a signal waveform. Smoothing may not be performed in the present exemplary embodiment and, for example, the gradient of a straight line defined by two points at two ends of section T3 may be calculated for a signal waveform that has not yet been smoothed.

In the first exemplary embodiment, when calculating a feature quantity (S2), determination device 50 calculates the gradient of straight line Ls defined by two points at two ends of section T3 and on a signal waveform as the gradient of the signal waveform as in part (D) of FIG. 7. In the present exemplary embodiment, the gradient of a signal waveform may be calculated by, for example, averaging the gradients of a plurality of straight lines that each approximate the signal waveform in the corresponding section formed by dividing section T3.

In the first exemplary embodiment, determination device 50 calculates the gradients of signal waveforms of heat radiation and visible light as feature quantities (S2). In the present exemplary embodiment, the feature quantity of gradient may be calculated based on either heat radiation or visible light. For example, whether to select heat radiation or visible light may depend on the material of workpiece 70, using heat radiation when the material is an aluminum material and using visible light when the material is an iron-based material. Whether to select heat radiation or visible light is not limited to such a way. Selection may depend on the absorption rate, according to a laser wavelength, of the material.

According to the determination method and the determination device of the present disclosure, a shift including farness and closeness of the focal position of a laser beam in an emission direction is determined. As a result, the processing state in laser processing for lap welding can be determined in detail.

The present disclosure is not limited to the exemplary embodiments described above, and various modifications can be made. That is, exemplary embodiments obtained by combining technical means suitably modified by those skilled in the art also fall within the scope of the present disclosure.

### INDUSTRIAL APPLICABILITY

The present disclosure is applicable to a determination system for determining a processing state in laser processing for lap welding, in particular, to a method and a device for determining a shift of the focal position of a laser beam.

### REFERENCE MARKS IN THE DRAWINGS

1: laser oscillator
2: laser transmission fiber
3: lens barrel
4: collimating lens
5, 11: condenser lens
6: laser beam
7: first mirror
8: second mirror
13: optical fiber
15: collimating lens
16: third mirror
17: fourth mirror
18: fifth mirror
19, 20, 21: condenser lens
22: optical sensor
23: transmission cable
24: controller
26: hold jig
27: molten portion
30: laser processing device
40: spectral device
50: determination device
51: CPU
52: communication circuit
53: storage device
56: control program
57: determination model
70: workpiece
F1: focal position
D1: training data
100: determination system

1. A determination method for determining a processing state in laser processing for lap welding, the determination method comprising:
detecting, using an optical sensor, at least one of heat radiation light, visible light, and reflected light generated at a welded portion formed at a surface of a workpiece by emission of a laser beam on the workpiece;
obtaining, from the optical sensor, a signal indicating a change in the at least one of heat radiation light, visible light, and reflected light in a time section corresponding to a welding time of the workpiece;
calculating a feature quantity including a gradient of a straight line approximating a signal waveform of the signal in a predetermined section in the time section;
determining, as the processing state, a shift including farness and closeness of a focal position of the laser beam in an emission direction of the laser beam by inputting the feature quantity to a determination model that determines the processing state; and
outputting the shift of the focal position as a determination result,
wherein the determination model is constructed based on training data including the feature quantity calculated under a condition where the shift of the focal position is present and the shift of the focal position, the feature quantity and the shift of the focal position being associated with each other.

2. The determination method according to claim 1, wherein the determination model includes a learned model generated by machine learning using training data, the training data including (i) a feature quantity calculated from a signal based on the at least one of heat radiation light, visible light, and reflected light detected during the laser processing under each condition of a plurality of conditions where the processing state changes and (ii) the shift of the focal position of the each condition, the feature quantity and the shift of the focal position being associated with each other.

3. The determination method according to claim 2, wherein
the shift of the focal position is determined with reference to a preset reference position on a lapping direction of the lap welding, and
the shift of the focal position includes a numerical value indicating a relative position of the focal position with respect to the reference position.

4. The determination method according to claim 1, wherein the calculating the feature quantity includes smoothing the signal waveform of the signal before calculating the feature quantity.

5. The determination method according to claim 1, wherein the feature quantity includes signal intensity of the signal.

6. The determination method according to claim 1, wherein the feature quantity includes an integrated value of the signal intensity of the signal.

7. A determination device for determining a processing state in laser processing for lap welding, the determination device comprising:
an arithmetic circuit; and
a communication circuit that receives a signal that is generated by an optical sensor detecting at least one of heat radiation light, visible light, and reflected light generated at a welded portion formed at a surface of a workpiece by emission of a laser beam on the workpiece,
wherein the signal indicates a change in the at least one of heat radiation light, visible light, and reflected light in a time section corresponding to a welding time of the workpiece,
the arithmetic circuit
obtains the signal by the communication circuit,
calculates a feature quantity including a gradient of a straight line approximating a signal waveform of the signal in a predetermined section in the time section,
determines, as the processing state, a shift including farness and closeness of a focal position of the laser beam in an emission direction of the laser beam by inputting the feature quantity to a determination model that determines the processing state, and
outputs the shift of the focal position as a determination result by the communication circuit, and
the determination model is constructed based on training data including the feature quantity calculated under a condition where the shift of the focal position is present and the shift of the focal position, the feature quantity and the shift of the focal position being associated with each other.

8. The determination device according to claim 7, wherein the determination model includes a learned model generated by machine learning using training data, the training data including (i) a feature quantity calculated from a signal based on the at least one of heat radiation light, visible light, and reflected light detected during the laser processing under each condition of a plurality of conditions where the processing state changes and (ii) the shift of the focal position of the each condition, the feature quantity and the shift of the focal position being associated with each other.

9. The determination device according to claim 8, wherein
the shift of the focal position is determined with reference to a preset reference position on a lapping direction of the lap welding, and
the shift of the focal position includes a numerical value indicating a relative position of the focal position with respect to the reference position.

10. The determination device according to claim 7, wherein the arithmetic circuit performs a process of smoothing the signal waveform of the signal before calculating the feature quantity.

11. The determination device according to claim 7, wherein the feature quantity includes signal intensity of the signal.

12. The determination device according to claim 7, wherein the feature quantity includes an integrated value of the signal intensity of the signal.
